(19) United States
(12) Patent Application Publication
(10) Pub. No.: US 2021/0221211 A1
(43) Pub. Date: Jul. 22, 2021

(54) CONFIGURABLE ELECTRIC VEHICLE POWER AND PROPULSION KIT

(71) Applicant: AFREECAR LLC, Rochester Hills, MI (US)

(72) Inventors: Christopher Borroni-Bird, Rochester Hills, MI (US); Richard Saad, Rochester, MI (US); Kazuhiro Saitou, Ann Arbor, MI (US); Mohsen Shabana, Farmington Hills, MI (US); Brian N. Bird, Berkshire (GB)

(21) Appl. No.: 17/247,909

(22) Filed: Dec. 30, 2020

Related U.S. Application Data
(60) Provisional application No. 62/954,979, filed on Dec. 30, 2019.

(51) Int. Cl. B60K 1/00; G06N 5/04; B60R 16/023

(52) U.S. Cl. CPC B60K 1/00; B60R 16/023; G06N 5/04

(57) ABSTRACT

A customizable power and propulsion kit includes is shown and described. The customizable power and propulsion kit includes an enclosure, an electric motor disposed in the enclosure, a battery disposed in the enclosure and electrically connected to the electric motor, and a connection point disposed on the enclosure, wherein the connection point facilitates connection of the kit to an object.

### CROSS-REFERENCE TO RELATED APPLICATIONS

This application claims priority to U.S. Provisional Patent Application No. 62/954,979 titled “Configurable Electric Vehicle Power and Propulsion Kit” filed on Dec. 30, 2019, the contents of which are hereby incorporated by reference in their entirety.

### BACKGROUND

Mobility improves quality of life by providing access to people, places, and experiences. Mobility efforts often involve deploying a fleet of small vehicles that can better maneuver densely populated urban areas or otherwise go where larger vehicles would be impractical. Improving mobility in an area, whether urban or rural, can have a positive impact on the local economy since mobility efforts can increase access to goods, services, and markets.

### BRIEF DESCRIPTION OF THE DRAWINGS

FIG. 1 illustrates example components of an electric vehicle power and propulsion kit that can be used to increase mobility efforts in a community.

FIG. 2 illustrates an example vehicle platform and solar panel roof.

FIG. 3 illustrates the electric vehicle power and propulsion kit having application-specific components supporting a pedal-assist implementation.

FIG. 4 illustrates the electric vehicle power and propulsion kit having application-specific components supporting a wheelbarrow implementation.

FIG. 5 is a flowchart illustrating an information connectivity check process executed by a validation computer.

FIG. 6 is a flowchart illustrating an electrical connectivity check process executed by the validation computer.

FIG. 7 is a flowchart of a mechanical connectivity check process executed by the validation computer.

FIG. 8 is a flowchart of a performance estimation process executed by the validation computer.

FIG. 9 is a graphical representation of an ordering process.

FIGS. 10A-10H are graphical representations of an assembling process.

FIGS. 11A-11B are graphical representations of the performance estimation process.

FIG. 12 is an example illustration of another example vehicle platform.

FIG. 13 is a block diagram showing example components of the example vehicle platform of FIG. 12.

FIG. 14 is a block diagram showing example components of a controller used to control the example vehicle platform of FIG. 12.

FIG. 15 is a block diagram illustrating an example controller for controlling the vehicle platform of FIG. 12.

FIG. 16 is a block diagram of an example closed-loop control system used in the block diagram of FIG. 15.

FIG. 17 is an illustration of another example vehicle platform having autonomous capabilities.

FIG. 18 illustrates an example vehicle platform in a horizontal position.

### DETAILED DESCRIPTION

Mobility solutions take many different forms. Sometimes a mobility solution involves providing transportation in a densely populated urban area. Other times, a mobility solution involves making it easier to transport goods or materials over a specific type of terrain in an undeveloped area. Different types of vehicles may be required in those instances. The vehicle that helps transport people through densely populated urban areas may not be the best way to transfer goods or materials over a specific type of terrain in an undeveloped area.

Customizable electric vehicle power and propulsion kits solve that problem. Electric vehicle power and propulsion kits can be customized based on the intended use of the electric vehicle. Electric motor size, battery size, axle configuration, etc., can all be configured to provide the appropriate mobility solution.

The customizable electric vehicle power and propulsion kit interfaces with a validation computer running a software program that can program, configure, control, validate, and govern the integration of flexible, upgradable attachments (e.g., mechanical machines, electrical machines, actuators, sensors, etc.) that can be driven by different power sources (e.g., solar, wind, water, plug-in, fuel, pedal, etc.).

The kit provides for substitution of existing power and propulsion sources (e.g., engines, motors, generators, etc.) for different transport modes on land, water, and air. That is, the kit may be used to build self-propelled rickshaws, tuk-tuks, pedi-cabs, golf carts, rail carts, drones, boats, or the like. The kit may further provide assistance to traditionally manually operated vehicles such as wheelbarrows, rickshaws, bicycles, etc. Some vehicles built from the kit may employ dual-mode solutions that “toggle” between different modes. For example, a rail cart may convert into a road vehicle. The kit provides an opportunity for building clean sheet (machine) solutions such as, e.g., a bicycle and motorized trailer. The kit may be further customized between providing basic functionality (e.g., solar-powered vehicles powered only by sunlight) to premium functionality (e.g., autonomous vehicles, high payload vehicles, and/or long-range vehicles).

The kit and software combination drive economic development by facilitating local labor and leveraging local resources for manufacturing and material sourcing including renewable materials, scrap materials, used batteries, and used vehicle parts. The kit and software combination enable transport and power services that provide affordable access to schools, hospitals, employment, markets, etc.

As discussed in greater detail below, the kit includes modules, attachments, modes, computers, and the software application. The modules are components that make up the kit, including a battery, solar panel, electric motor, the frame, etc. some components can be varied and application-depending. That is, a small battery for voltage stabilization purposes can be used with a solar powered motor with no energy storage.

The attachments can be open-source attachments, existing components, or the like. Examples may include a water pump, a corn grinder, a propeller, a refrigerator, lighting, etc.

The mode may refer to a vehicle body/chassis that attaches to the kit and converts it into a complete vehicle. The kit may be used to create an existing vehicle or a new type of vehicle. The computers may allow for initial configuration and installation of the kit into the particular mode. Further, the computer may validate the assembly for safety and operational design domain. In some instances, the computer may server as a governor via, e.g., a load cell incorporated into the kit that confirms that weight limits are respected. The computer can also confirm that the vehicle resulting from the kit complies with reasonable and customary guidelines for similar types of vehicles. If custom designs are provided, the computer can confirm that the kit is suitable for its intended use. That is, the computer can verify the scenario/use case against the capabilities of the vehicle formed the kit. The capabilities may include, e.g., towing, trailer mass, tongue weight, etc.

The computer can also be used to capture and display pictograms and photographs representing viable and non-viable options. These can include the mode, wheels/tires, materials, and gauge thickness given the intended use of the vehicle. The computer may permit customizations such as selection of particular motors, engines, propulsion units given the intended use. The computer may facilitate software upgrades, hardware changes, and validations as a result of any hardware changes. The computer may provide remote diagnostics, advanced driver assistance systems (ADAS) alerts, route planning, real-time vehicle range estimations, and other functionality. Further, the computer may provide a human-machine interface for authentication, display information such as range information, routes, and alerts, and facilitate payment transactions.

The software may be incorporated into the computer to facilitate some or all of the features of the computer. The software may consolidate, in real time, information from various sources. The information may include Global Navigation Satellite System (GNSS) information, weather information, local news, traffic, routes, and markets. In some instances, the software may handle transactions. Further, the software may leverage cloud-based information such as AI or machine learning, aggregated data and analytics, libraries, or the like.

The kit may be provided in various versions based on the intended use of the vehicle. Referring to electrical generation and storage, the various versions may include or omit a power generator. Examples of power generators may include a solar panel, wind turbine, external battery, or plug outlet. For instance, one version may require that the kit be plugged in to power its components. A second version may include only a small battery for voltage stabilization for, e.g., a solar-powered motor. This second version may, therefore, be limited to daytime operation. A third version may include a larger battery for energy storage, operation at night, power surges for power take-off, etc. In some instances, the kit may re-use lithium ion battery module from a used EV.

Referring now to mechanical power generation, the kit may provide an electric motor driven axle with variable motor and/or axle sizes depending on the intended use of the vehicle. As alluded to above, the kit may provide an interface for power take-off that can be used to power water pumps, air compressors, mechanical machines (e.g., cereal grinders), etc. The kit may provide a motor that can be operated in reverse to act as a generator when attached to, e.g., a wind turbine, a water turbine, or manually operated pedals. A motor controller may also be customized for the intended vehicle operation. In some instances, the motor controller may be programmed to limit the use of the motor to, e.g., prevent damage caused by improper use.

The kit can be used to power different types of vehicles, including non-traditional vehicles. For example, the kit can be used to power wheel/ball wheelbarrows, golf carts, etc. Other types of vehicles that can be powered by the kit can include rail carts using steel wheels and operating on rail lines, off-road tanks using tracks as opposed to wheels, motorboats using waterways, and drones using airspace. Additional power applications can include using the power take-off feature for non-motive applications such as generating electrical power, powering electrical outlets, and powering features such as lighting, refrigeration, cellphone charging, etc.

The kit may integrate with a validation computer, which in some instances could be a user's smartphone or a computer located on the kit. The validation computer configures the kit to provide optimal performance and protection from improper vehicle use via setup options and warnings. The validation computer can also be used to toggle various modes of operation such as, e.g., providing motive power, using the power take-off feature, using the generator, etc. The validation computer may link to the kit via wired and/or wireless interfaces. The validation computer may provide diagnostics, user interface, authentication, route optimization, range estimation, solar panel angle optimization, advanced driver assistance systems (ADAS), low speed autonomy (e.g., with additional wirelessly connected cameras), etc. The validation computer may further be used to capture images of the vehicle and/or the environment in which the vehicle is intended to be used. Moreover, the validation computer can be used for transactional purposes so the use of the vehicle can be monetized.

Through various mechanical integrations, the kit can operate as a “standalone trailer,” integrated into clean sheet vehicle designs, or retrofit into existing manually operated or gasoline fueled internal combustion engine vehicles. A library of proprietary and/or open source designs can be provided so purchasers of the kit will have access to information regarding viable and non-viable structures, materials, tires, etc. Physical attachment points may be adjusted to accommodate the wide variety of possible vehicle dimensions and intended uses. Further, the validation computer may control motor performance and/or provide feedback on the integration using, e.g., a load cell sensor to ensure that a payload has not been exceeded.

The elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

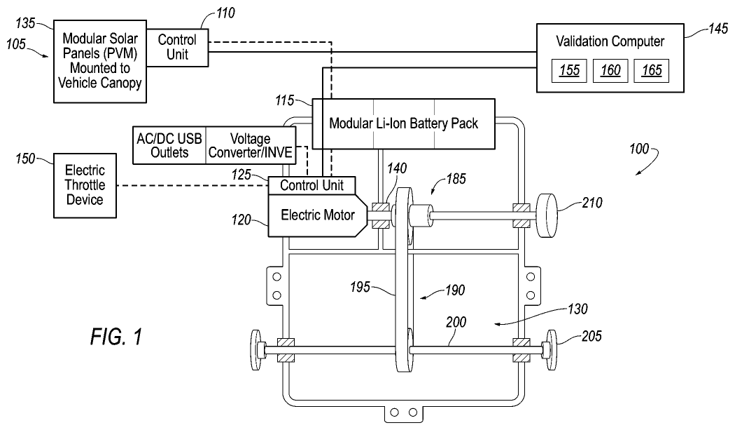

As illustrated in FIG. 1, the electric vehicle power and propulsion kit 100 includes a generator 105, a generator controller 110, a battery 115, an electric motor 120, a motor controller 125, and a powertrain 130.

The generator 105 is a device that converts one form of energy into electrical energy. The generator 105 may include one or more solar panels that convert sunlight into electricity. Each solar panel 135 may include an array of photovoltaic cells that receive the sunlight and output electrical energy proportional to the amount of sunlight received. The electrical energy generated by the generator 105 may be direct current electrical energy provided to, e.g., the battery 115.

The generator controller 110 is a microprocessor-based controller implemented via circuits, chips, or other electronic components. For example, the generator controller 110 may include a processor, memory, etc. The memory of the generator controller 110 may include memory for storing instructions executable by the processor as well as for electronically storing data and/or databases. The processor of the generator controller 110 is implemented via circuits, chips, or other electronic component and may include one or more microcontrollers, one or more field programmable gate arrays (FPGAs), one or more application specific integrated circuits (ASICs), one or more digital signal processors (DSPs), one or more customer specific integrated circuits, etc. The generator controller 110 may be configured and/or programmed to provide one-way transfer of the electrical energy generated by the generator 105 to the battery 115. As such, the generator controller 110 may include electronic components such as transistors, resistors, capacitors, diodes, switches, relays, etc. The components may be arranged in one or more circuits, such as a DC-to-DC converter circuit to provide electrical energy to the battery 115.

The battery 115 is an electrical storage device with rechargeable electrochemical cells. The amount of energy stored in the battery 115 may be based on the number and/or size of electrochemical cells. The battery 115 may be electrically connected to the generator 105 and to the electric motor 120. Electrical energy generated by the generator 105 may be stored in the battery 115. Thus, the electrical energy received from the generator 105 may be used to recharge the battery 115. The electrical energy stored in the battery 115 may be provided to the electric motor 120 as direct current electrical energy.

The electric motor 120 is an electrical machine that converts electrical energy into mechanical energy. The electric motor 120 may receive direct current electrical energy output by the battery 115, and the electrical energy received from the battery 115 may cause a rotor to rotate. The rotor may include or be connected to a drive shaft 140 that extends from the electric motor 120. The shaft rotates with the rotation of the rotor to provide torque that, e.g., drives the powertrain 130.

The motor controller 125 is a microprocessor-based controller implemented via circuits, chips, or other electronic components. For example, the motor controller 125 may include a processor, memory, etc. The memory of the motor controller 125 may include memory for storing instructions executable by the processor as well as for electronically storing data and/or databases. The processor of the motor controller 125 is implemented via circuits, chips, or other electronic component and may include one or more microcontrollers, one or more field programmable gate arrays (FPGAs), one or more application specific integrated circuits (ASICs), one or more digital signal processors (DSPs), one or more customer specific integrated circuits, etc. The motor controller 125 is configured and/or programmed to control the operation of the electric motor 120. For example, the motor controller 125 may output signals the cause the electric motor 120 to draw a particular current or voltage from the battery 115. As such, the generator controller 110 may include electronic components such as transistors, resistors, capacitors, diodes, switches, relays, etc. The motor controller 125 may further include or operate in accordance with a DC-to-DC voltage converter 265 so the appropriate amount of electrical energy is provided from the battery 115 to the electric motor 120.

The motor controller 125 may further include interfaces for receiving signals from and transmitting signals to other components. For example, the motor controller 125 may include a computer interface for communication with a validation computer 145. The computer interface may be a standard interface, such as a Universal Serial Bus (USB) interface, or a non-standard interface. The interface may further allow the motor controller 125 to receive signals from other devices such as, e.g., an electric throttle device 150, the generator controller 110, the battery 115, etc.

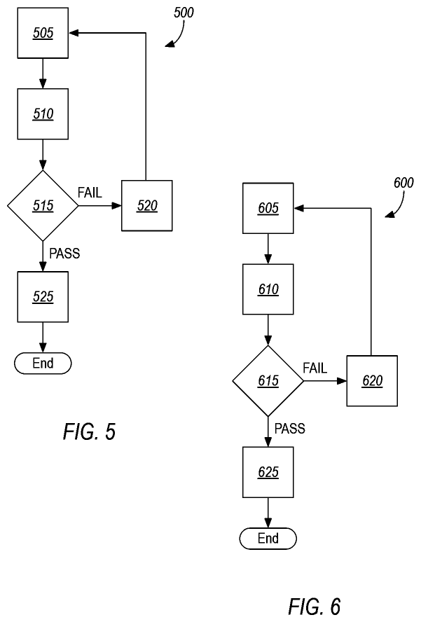

The validation computer 145 is a microprocessor-based controller implemented via circuits, chips, or other electronic components. For example, the validation computer 145 may include a processor, memory, etc. The memory of the validation computer 145 may include memory for storing instructions executable by the processor as well as for electronically storing data and/or databases. The processor of the validation computer 145 is implemented via circuits, chips, or other electronic component and may include one or more microcontrollers, one or more field programmable gate arrays (FPGAs), one or more application specific integrated circuits (ASICs), one or more digital signal processors (DSPs), one or more customer specific integrated circuits, etc. The validation computer 145 is configured and/or programmed to perform various processes that will be discussed below with respect to FIGS. 5-11B. Additional components of the validation computer 145 may include a location circuit 155 that, e.g., uses the global positioning system (GPS) to triangulate its position, a camera 160 used to capture images, video, or both, a communication transceiver 165 that allows the validation computer 145 to wirelessly communicate with a remote (i.e., cloud-based) server 165, a user input device 170 such as a keyboard, mouse, touchscreen, touchpad, etc., and/or a display device 180 such as a monitor or touchscreen. Accordingly, the validation computer 145 may be a smartphone, a tablet computer, a handheld computer, or a laptop computer. In some possible approaches, the validation computer 145 is a handheld computing device with a display that is provided with the kit 100.

The camera 160, which may be incorporated into the validation computer 145, is a vision sensor. The camera 160 may capture images of parts of the kit 100, parts of the vehicle formed from the kit 100, parts of another vehicle, an area where the vehicle will be used, etc. To capture such images, the camera 160 may include a lens that projects light toward, e.g., a CCD image sensor, a CMOS image sensor, etc. The camera 160 processes the light and generates the image. The image may be output to the processor and, as discussed in greater detail below, can be used to confirm that the kit 100 was assembled correctly, identify the type of environment in which the vehicle formed from the kit 100 will be used, and/or determine the type of kit 100 needed.

The communication transceiver 165 is implemented via an antenna, circuits, chips, or other electronic components that facilitate wireless communication between the validation computer 145 and a remote server 165. The communication transceiver 165 may be programmed to communicate in accordance with any number of wired or wireless communication protocols. For instance, the communication transceiver 165 may be programmed to communicate in accordance with a satellite-communication protocol, a cellular-based communication protocol (5G, LTE, 3G, etc.), Bluetooth®, Bluetooth® Low Energy, Ethernet, the Controller Area Network (CAN) protocol, WiFi, the Local Interconnect Network (LIN) protocol, etc. In some instances, the communication transceiver 165 is incorporated into a vehicle telematics unit.

The remote server 165 is a computer wirelessly accessible to the validation computer 145. The remote server 165 may be, e.g., a cloud-based server. In some instances, the remote server 165 is able to collect information from multiple validation computers 145 and provide aggregated information to one or more validation computers 145. In other words, the remote server 165 may crowdsource certain information to provide better feedback and recommendations, as discussed below, to the validation computer 145.

The powertrain 130 includes components that can be used to propel the vehicle on which the kit 100 is installed. The powertrain 130 may include a clutch mechanism 185, sprockets/pulleys 190, a chain or belt drive 195, a drive axle 200, wheel flanges 205, and a power take-off pulley 210.

Certain components of the powertrain 130 may be mounted to a frame 215 which may also serve as the vehicle chassis. The clutch mechanism 185 may be mechanically connected to the output shaft of the electric motor 120. The clutch mechanism 185 may include gears 240 that engage to transfer the torque generated by the electric motor 120 to a sprocket/pulley 190A. The rotation of the sprocket/pulley 190A causes the drive axle 200 to rotate because the chain or belt drive 195 is attached to one sprocket/pulley 190A at one end and another sprocket/pulley 190B attached to the drive axle 200. The rotation of the drive axle 200 causes wheels mounted to the wheel flanges 205 to rotate and propel the vehicle.

The power take-off pulley 210 may also be attached to the output shaft of the electric motor 120. As a result, the torque provided by the electric motor 120 can be used to drive other components such as a water pump, propeller, etc.

Other components of the vehicle that may be used with the kit 100 include, e.g., a steering system, wheels, brakes, etc. One or more of these components may be powered by the battery 115 and/or in signal communication with the generator controller 110, the electric motor controller 125, the validation computer 145, etc.

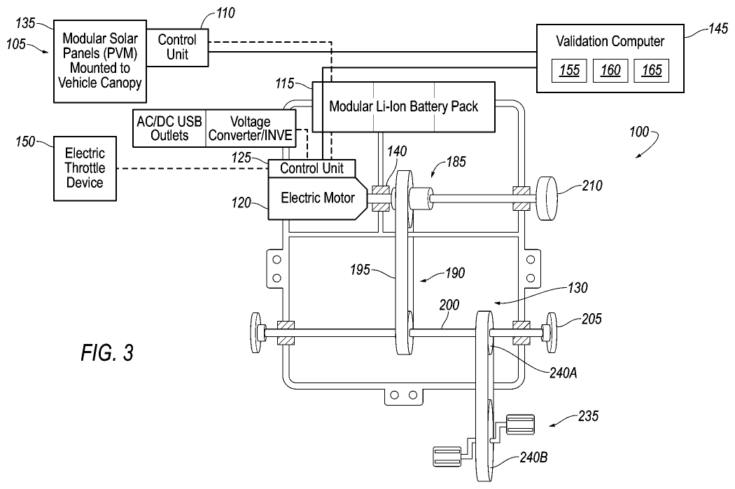

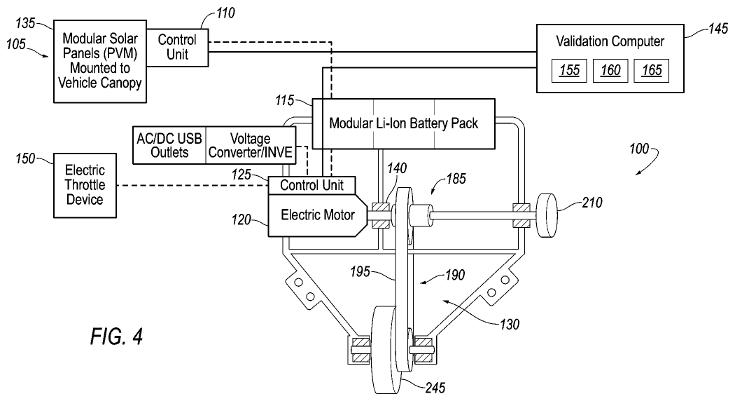

Some components shown in FIG. 1 may be customized according to the intended use of the vehicle. The size of the battery 115, the size of the electric motor 120, and the sizes and configurations of the frame 215, chain/belt drive, sprockets/pulleys 190, drive axle 200, and wheel flanges 205 may be based on how the vehicle is intended to be used. Kits for vehicles intended to carry heavy loads may require larger batteries and electric motors than those for vehicles intended to carry lighter loads. Further, kits for vehicles used in rough terrain may require a thicker drive shaft 140 to support heavier tires and increased vibrations. Finally, as discussed below with respect to FIGS. 3-4, the frame 215, drive axle 200, and number of wheels may be modified to accommodate different types of vehicle platforms.

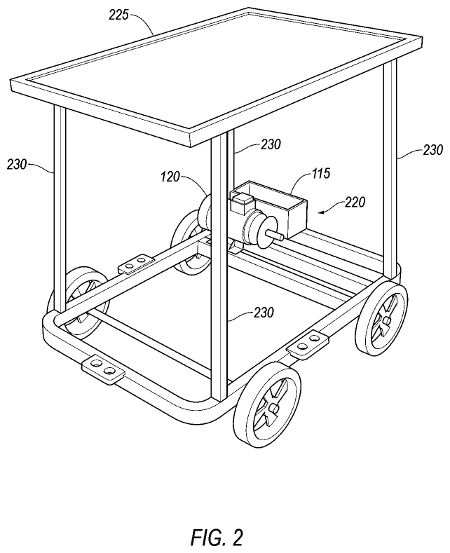

FIG. 2 illustrates an example vehicle platform 220 and solar panel roof 225 after the kit 100 has been installed.

The vehicle platform 220 is shown in FIG. 2 with the frame 215, two drive axles 200 mounted to the frame 215, wheels installed on each of the drive axles 200, the electric motor 120 attached to the frame 215, and the battery 115 attached to the frame 215. The platform may be in the shape of a tray (rather than a box) to, e.g., lower the center of gravity and to create a more functional skateboard platform. Example dimensions of cylindrical cells used to form the vehicle platform 220 may be on the order of 200 mm×500 mm×75 mm (approximately 8″ long×20″ wide×3″ thick). Components with non-moving parts such as the motor controller 125 and battery pack can be hard-mounted directly to the frame 215 with fasteners. Rubber isolators may be placed between mounting brackets used to attach the electric motor 120 to the frame 215 to control vibrations. Further, fasteners can be used for ease of service.

The type of wheels used may be application-dependent. Bicycle wheels/tires can be used on paved roads, moped wheels/tires can be used for off-road rural use, steel wheels can be used on rail lines. One option may allow for a one-wheel wheelbarrow having either a wheel or a ball. For certain land applications, tracks instead of wheels might be attached. For water applications, a horizontal axis steerable propeller could be mounted to the power take-off unit to create a solar-powered electric motorboat. For aerial use drone applications, four vertical axis propellers may be attached.

Axles are mounted to bearings that are inserted into a bearing-housing on the frame 215. Bicycle gears (sprockets) and chains could be used for lighter duty loads, Heavier gears and belts may be used with higher load applications

The solar panel roof 225 is shown above the vehicle platform 220. In some implementations, the roof may be attached to the frame 215 via posts 230. The posts 230 may be directly attached to the frame 215. Alternatively, the posts 230 may be attached to, e.g., four-side extensions on the frame 215. The posts 230 may be manually adjusted to a desired length. Further, each post 230 may be separately adjusted relative to other posts 230. Therefore, the posts 230 may be adjusted in a way that allows the solar panel roof 225 to rest at an angle. Such an orientation may be desired to, e.g., face the solar panel roof 225 toward the sun as well as provide a non-horizontal surface to discourage using the solar panel roof 225 as a storage rack. Accordingly, the posts 230 may attach to the solar power roof via, e.g., bushings or another assembly that allows the solar panel roof 225 to tilt toward the sun. In some instances, the posts 230 may be attached to actuators that cause the posts 230 to telescope. Therefore, the actuators may automatically adjust the length of each post 230. The actuators may be controlled by the validation computer 145 (discussed in greater detail below), the electric motor controller 125, the generator controller 110, etc.

Even in instances where the posts 230 are manually adjusted, the validation computer 145 may be programmed to output instructions via its display device 180 for the best way to orient the posts 230 so that the solar panel roof 225 is facing the sun at the most efficient angle to capture electrical energy. For instance, the posts 230 may include markings, and the validation computer 145 may output instructions that instruct the operator to set each post 230 at a particular height according to the markings on the post 230. The validation computer 145 may be programmed to make such a recommendation based on, e.g., the location of the vehicle, the time of day, the weather, and possibly other factors.

FIG. 3 illustrates the electric vehicle power and propulsion kit 100 having application-specific components supporting a pedal-assist implementation. As shown in FIG. 3, a pedal assembly 235 is attached to the drive axle 200. The pedal assembly 235 includes gears 240A and B, a belt driving the gears 240, and pedals. Gear 240A may be fixed to the drive axle 200. Gear 240B may be fixed to the pedals. Operating the pedals may cause gear 240B to rotate. The belt, attached to gear 240A and gear 240B, may cause gear 240A to rotate in accordance with the rotation of gear 240B. Therefore, the vehicle may be driven through the pedal assembly 235. Further, since the pedal assembly 235 and the electric motor 120 are both operably connected to the drive axle 200, the electric motor 120 may provide a pedal assist function.

FIG. 4 illustrates the electric vehicle power and propulsion kit 100 having application-specific components supporting a wheelbarrow implementation. In this example, a wheelbarrow wheel 245 is attached to the drive axle 200. The electric motor 120, therefore, is able to rotate the wheelbarrow wheel 245. In that regard, the wheelbarrow becomes self-propelled to help a user move the wheelbarrow more easily over, e.g., rough terrain.

FIG. 5 is a flowchart illustrating an information connectivity check process 500 executed by the validation computer 145. The information connectivity check process 500 may begin at any time, such as when the vehicle is assembled using parts from the kit 100 to confirm, e.g., that certain vehicle components are able to communicate with one another. In some instances, the validation computer 145 may prompt a user to perform the information connectivity check process 500 via, e.g., a notification presented on the display device 180 of the validation computer 145.

At block 505, the validation computer 145 receives location data from the location circuit 155. The location data may include GPS data such as coordinates indicating where the validation computer 145 is located.

At block 510, the validation computer 145 receives a signal from the motor controller 125. The signal from the motor controller 125 need not necessarily transmit any particular information at block 510. Rather, the mere presence of the signal may indicate that the validation computer 145 and motor controller 125 are able to communicate via the computer interface, which as discussed above may be a USB interface. In some instances, the validation computer 145 may prompt the motor controller 125 to respond with the signal.

At decision block 515, the validation computer 145 determines whether the location data was received from the location circuit 155 and whether the signal was received from the motor controller 125. If one or both conditions are not met, the process 500 proceeds to block 520. If both conditions are met, the process 500 proceeds at block 525.

At block 520, the validation computer 145 displays a notification indicating that the information connectivity check failed. The validation processor may be programmed to command its display device 180 to show the notification. The process 500 may return to block 505 so that the information connectivity check can be repeated. In some instances, there may be a short delay before the process 500 returns to block 505. The delay may be time-based (e.g., the validation computer 145 waits a predetermined amount of time before executing block 505 again) or event based (e.g., the validation computer 145 waits to receive a user input before restarting the process 500 at block 505).

At block 525, the validation computer 145 displays a notification indicating that the information connectivity check has been passed. The validation processor may be programmed to command its display device 180 to show the notification. The process 500 may end after block 525.

FIG. 6 is a flowchart illustrating an electrical connectivity check process 600 executed by the validation computer 145. The electrical connectivity check process 600 may begin at any time, such as when the vehicle is assembled using parts from the kit 100 to confirm, e.g., that certain vehicle components are able to receive electrical energy from the generator 105 or the battery 115. In some instances, the validation computer 145 may prompt a user to perform the electrical connectivity check process 600 via, e.g., a notification presented on the display device 180 of the validation computer 145.

At block 605, the validation computer 145 receives status signals from one or more vehicle components such as the electric motor 120, motor controller 125, headlights, or other vehicle components that are powered by the battery 115. The status signal may indicate that the component is receiving electrical energy. For example, the status signal may indicate that one or more of the electric motor 120, the motor controller 125, the headlights, etc., are receiving power from the battery 115.

At block 610, the validation computer 145 receives a status signal from the battery 115. The status signal from the battery 115 may indicate that the battery 115 is receiving electrical energy from the generator 105, outputting electrical energy to, e.g., the components referenced at block 605, or both. Therefore, the status signal may indicate that the battery 115 is receiving power from the generator 105, outputting power to vehicle components, or both.

At decision block 615, the validation computer 145 determines, from the status signals received at block 605, if the components of the vehicle are properly powered by the battery 115. The validation computer 145 may further determine, from the status signal received at block 610, if the battery 115 is outputting power to the vehicle components, receiving power from the generator 105, or both. If the signals received at block 605 and/or block 610 indicate that one or more vehicle components are not receiving or outputting electrical energy as expected, the process 600 may proceed to block 620. If the signals received at blocks 605 and 610 indicate that the vehicle components are electrically connected to one another, the process 600 proceed to block 625.

At block 620, the validation computer 145 displays a notification indicating that the electrical connectivity check failed. The validation processor may be programmed to command its display device 180 to show the notification. The process 600 may return to block 605 so that the electrical connectivity check can be repeated. In some instances, there may be a short delay before the process 600 returns to block 605. The delay may be time-based (e.g., the validation computer 145 waits a predetermined amount of time before executing block 605 again) or event based (e.g., the validation computer 145 waits to receive a user input before restarting the process 600 at block 605).

At block 625, the validation computer 145 displays a notification indicating that the electrical connectivity check has been passed. The validation processor may be programmed to command its display device 180 to show the notification. The process 600 may end after block 625.

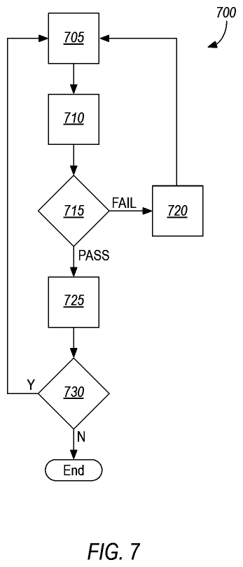

FIG. 7 is a flowchart of a mechanical connectivity check process 700 executed by the validation computer 145. The mechanical connectivity check process 700 may begin at any time, such as when the vehicle is assembled using parts from the kit 100 to confirm, e.g., that certain vehicle components are properly connected (mechanically) to one another. In some instances, the validation computer 145 may prompt a user to perform the mechanical connectivity check process 700 via, e.g., a notification presented on the display device 180 of the validation computer 145.

At block 705, the validation computer 145 receives an image of an assembled part of the vehicle. The assembled part of the vehicle may include components of the kit 100, components that were not part of the kit 100, or a combination of both. The image may be captured via the validation computer 145 using, e.g., the camera 160 of the validation computer 145.

At block 710, the validation computer 145 transmits the image received at block 705 to the remote server 165. The remote server 165 processes the image of the assembled part using an image processing technique to determine whether or not the part was assembled correctly. The validation computer 145 may transmit the image to the remote server 165 via, e.g., the communication transceiver 165. In some instances, the validation computer 145 may perform the image processing technique at block 710 rather than transmit the image to the remote server 165.

At decision block 715, the validation computer 145 determines whether the assembled part was assembled correctly. In some instances, the validation computer 145 may receive a response from the remote server 165 that indicates that, as a result of the image processing performed by the remote server 165, the image shows that the part was correctly assembled or that the image shows that the part was incorrectly assembled. If the response from the remote server 165 indicates that the part was incorrectly assembled, or if the validation computer 145 otherwise determines that the part was incorrectly assembled, the process 700 proceeds to block 720. If the response from the remote server 165 indicates that the part was correctly assembled, or if the validation computer 145 otherwise determines that the part was correctly assembled, the process 700 proceeds to block 725.

At block 720, the validation computer 145 displays a notification indicating that the mechanical connectivity check failed. The validation processor may be programmed to command its display device 180 to show the notification. The process 700 may return to block 705 so that the mechanical connectivity check can be repeated for the part that was incorrectly assembled. In some instances, there may be a short delay before the process 700 returns to block 705. The delay may be time-based (e.g., the validation computer 145 waits a predetermined amount of time before executing block 705 again) or event based (e.g., the validation computer 145 waits to receive a user input before restarting the process 700 at block 705).

At block 725, the validation computer 145 displays a notification indicating that the mechanical connectivity check has been passed. The validation processor may be programmed to command its display device 180 to show the notification.

At decision block 730, the validation computer 145 determines whether to perform additional mechanical connectivity checks. The validation computer 145 may determine whether to perform additional connectivity checks by prompting the user via a notification displayed on the display device 180 of the validation computer 145. The prompt may give the user an opportunity to indicate whether another part has been assembled and is ready for the mechanical connectivity check. In some instances, the validation computer 145 may display instructions for assembling the next part either before or along with the prompt. The user may provide a response to the prompt via the user input device 170 of the validation computer 145. If the validation computer 145 determines from, e.g., the user response to perform more mechanical connectivity checks, the process 700 proceeds to block 705. If the validation computer 145 determines that no more mechanical connectivity checks are needed, the process 700 may end.

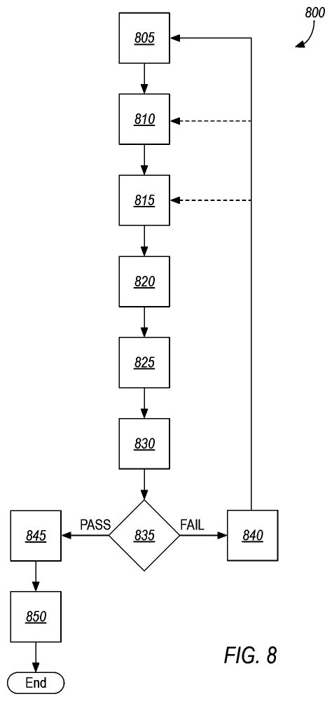

FIG. 8 is a flowchart of a performance estimation process 800 executed by the validation computer 145. The performance estimation check process 800 may begin at any time, such as after the vehicle has been assembled using parts from the kit 100 to estimate, e.g., how the vehicle will perform given its environment. In some instances, the validation computer 145 may prompt a user to perform the performance estimation check process 800 via, e.g., a notification presented on the display device 180 of the validation computer 145.

At block 805, the validation computer 145 receives location data from the location circuit 155. The location data may include GPS data such as coordinates indicating where the validation computer 145 is located.

At block 810, the validation computer 145 receives information about the vehicle. The information about the vehicle includes information about the components included in the kit 100 and information about components of the vehicle that were not included in the kit 100, if any. The information about the vehicle may include the specifications of each component. The specifications may include the size of the battery 115, the size and/or strength of the electric motor 120, the charging capabilities of the generator 105, the size of the wheels, the configuration of the clutch mechanism 185 and gears 240, the weight of the vehicle, and so on. The information about the vehicle may be received via images captured by the camera 160 of the validation computer 145, information provided by the user such as information typed into the validation computer 145 via, e.g., the user input device 170, or the like.

At block 815, the validation computer 145 receives environmental information. The environmental information may include a present weather forecast, a future weather forecast, terrain information, etc. The terrain information may refer to characteristics of the environment where the vehicle is intended to be used. The terrain information may reflect the type of road surface (e.g., paved, dirt, grassy, rocky, wet, etc.), whether the terrain is hilly or flat, whether the vehicle will be exposed to direct sunlight, etc.

At block 820, the validation computer 145 prompts the user to operate the vehicle in a particular way. The prompt may be displayed on the display device 180 of the validation computer 145. The prompt may include instructions such as “Move the vehicle forward 3 meters.”

At block 825, the validation computer 145 records the movement of the vehicle as a video. The validation computer 145 may record the movement of the vehicle using, e.g., the camera 160.

At block 830, the validation computer 145 transmits the video captured at block 825 to the remote server 165. The remote server 165 processes the video of the assembled part using a video processing technique to determine whether or not the vehicle moved in an expected way given the location data, the information received at block 810, the environmental information received at block 815, or a combination thereof. The validation computer 145 may transmit the video to the remote sever via, e.g., the communication transceiver 165. In some instances, the validation computer 145 may perform the video processing technique at block 830 rather than transmit the video to the remote server 165.

At decision block 835, the validation computer 145 determines whether the vehicle performed as expected. In some instances, the validation computer 145 may receive a response from the remote server 165 that indicates that, as a result of the video processing performed by the remote server 165, the video shows that the vehicle operated as expected or that the vehicle did not operate as expected. If the response from the remote server 165 indicates that the vehicle operated in an unexpected way, or if the validation computer 145 otherwise determines that the vehicle operated in an unexpected way, the process 800 proceeds to block 840. If the response from the remote server 165 indicates that the vehicle operated in an expected way, or if the validation computer 145 otherwise determines that the vehicle operated in an expected way, the process 800 proceeds to block 845.

At block 840, the validation computer 145 displays a notification indicating that the performance cannot be estimated because the vehicle did not perform as expected. The validation processor may be programmed to command its display device 180 to show the notification. The notification may include instructions for providing updated information, or possibly modifying the vehicle, to be able to estimate the performance. The modifications to the vehicle may include instructions for fixing electrical and/or mechanical connections between various components of the vehicle. The process 800 may return to any of blocks 805, 810, or 815 so that the additional information can be provided.

At block 845, the validation computer 145 determines the expected performance of the vehicle. The expected performance of the vehicle may be determined from the analysis of the video at block 835 as well as the information received at blocks 805, 810, and 815. In some instances, the expected performance is determined by the remote server 165 and transmitted to the validation computer 145. In other instances, the validation computer 145 is able to determine the expected performance locally (i.e., without use of the remote server 165).

At block 850, the validation computer 145 displays the expected performance of the vehicle. The expected performance may include an expected range of the vehicle, how long until the battery 115 will need to be recharged, the maximum vehicle speed, a recommended angle of the solar power roof, etc. The validation processor may be programmed to command its display device 180 to show the expected performance. The process may end after block 845.

FIG. 9 is a graphical representation of an ordering process. As shown in FIG. 9, the camera 160 of the validation computer 145 can be used to capture an image of a desired vehicle. The image can be transmitted to the remote server 165. The remote server 165 may store a database listing multiple kits that can be used to at least partially create vehicles, including the desired vehicle. The remote server 165 may be programmed to respond with recommendations for kits that can be used to build the desired vehicle. The recommendation may further include a component list along with other suggested components (not included in the kit 100) that may be used to manufacture the desired vehicle.

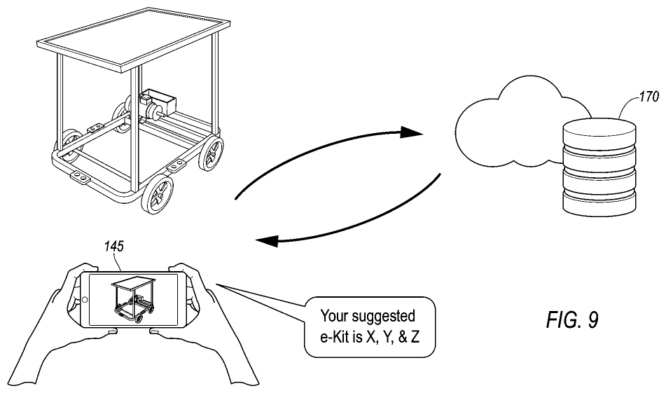

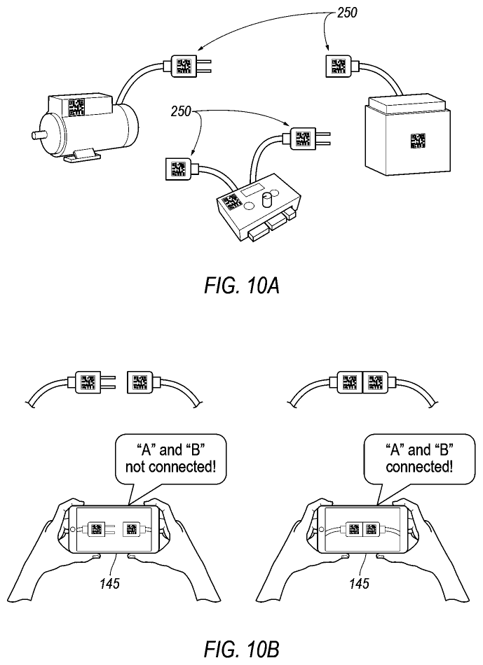

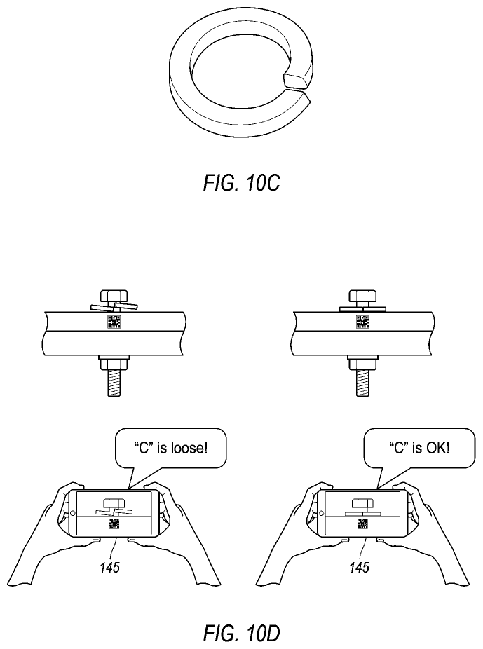

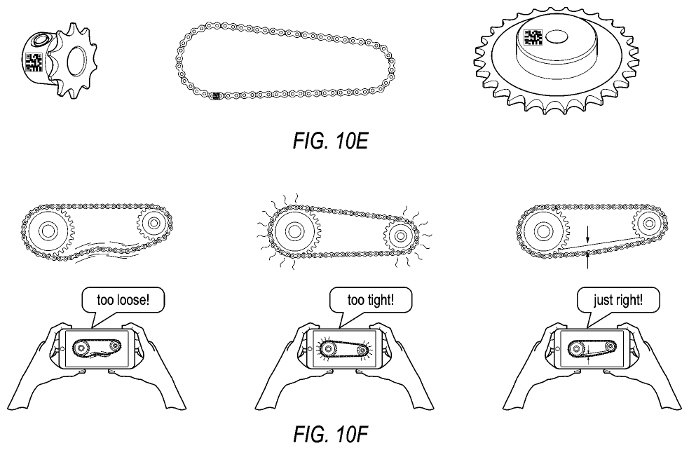

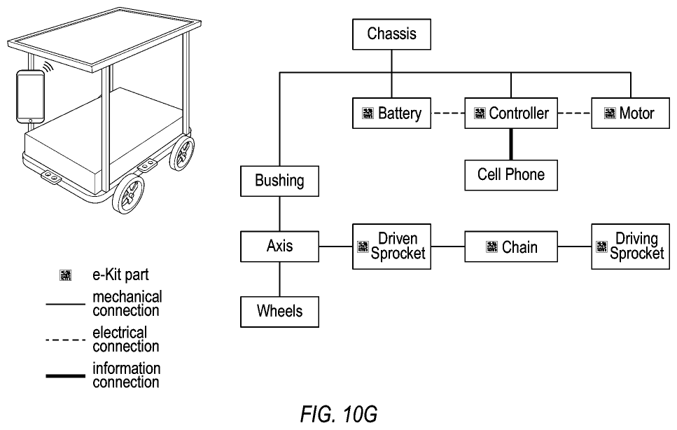

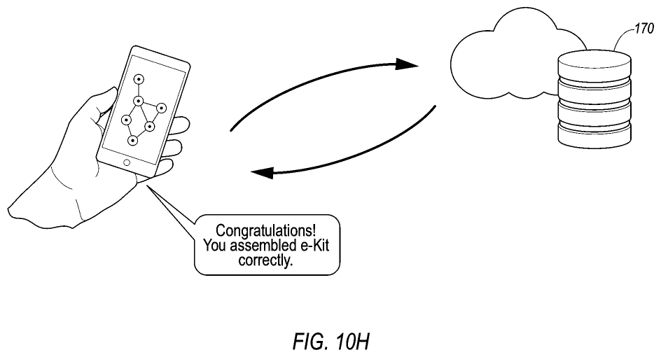

FIGS. 10A-10H are graphical representations of an assembling process that will help the vehicle pass the information connectivity check process 500, the electrical connectivity check process 600, and the mechanical connectivity check process 700.

As shown in FIG. 10A, the components of the kit 100 include a unique product identifier 250. The unique product identifier 250 is shown as a QR code but could be any other type of machine-readable identifier such as alphanumeric characters, an image, a barcode, etc. Each electrical terminal may also include a unique product identifier 250.

Referring now to FIG. 10B, the user can use the validation computer 145 to capture an image of components electrically connected to one another. The image may include the unique product identifiers 250 on the terminals of the components. Using the unique product identifiers 250 and an image processing technique, the validation computer 145 can determine whether the components were properly connected. That is, the validation computer 145 can use the unique product identifiers 250 to determine whether the components should be electrically connected. The validation computer 145 can further use the image processing technique to determine if the components are fully connected. The validation computer 145 may output a notification via the display device 180. The notification may reflect whether or not the components were properly connected.

FIGS. 10C-10F are graphical representations showing examples of confirming mechanical connections. FIG. 10C illustrates an example spring-lock washer that can be used in the vehicle. In FIG. 10D, the validation computer 145 uses the unique product identifier 250 to detect the frame 215 and an image processing technique to determine whether a bolt is fully fastened. The image processing technique may use edge detection to see if the edges of the washer align since aligned edges would indicate that the bolt is fully tightened. The validation computer 145 may output a notification via the display device 180 indicating whether the washer was fully tightened.

FIG. 10E is a similar example with drivetrain components. Each component includes the unique product identifier 250 that the validation computer 145 can use to identify the component. In FIG. 10F, the validation computer 145 uses an image processing technique to determine whether the chain is too loose, too tight, or just right. The image processing technique may consider the distance between the centers of the gears 240, the number of links in the chain, the angle of the chain relative to a line defined by the centers of the gears 240, etc. The validation computer 145 may output a notification via the display device 180 indicating whether the drivetrain components were properly assembled.

FIG. 10G generates a graph showing the mechanical, electrical, and information connections between the components of the vehicle. The validation computer 145 may generate such a graph after the vehicle is assembled using the techniques shown in FIGS. 10A-10F.

Referring now to FIG. 10H, the validation computer 145 transmits the graph generated in FIG. 10G to the remote server 165. The remote server 165 compares the graph with various configurations of assembled vehicles stored in a database. The remote server 165 confirms whether the graph matches one of the stored configurations. If so, the remote server 165 sends a confirmation signal to the validation computer 145, and the validation computer 145, in turn, displays the confirmation on the display device 180. If the graph does not match any stored configurations, the remote server 165 may transmit a signal to the validation computer 145 so the user can troubleshoot the configuration. In that instance, the validation computer 145 may instruct the user to repeat the process shown in FIGS. 10A-10G to try to troubleshoot any issues with the configuration.

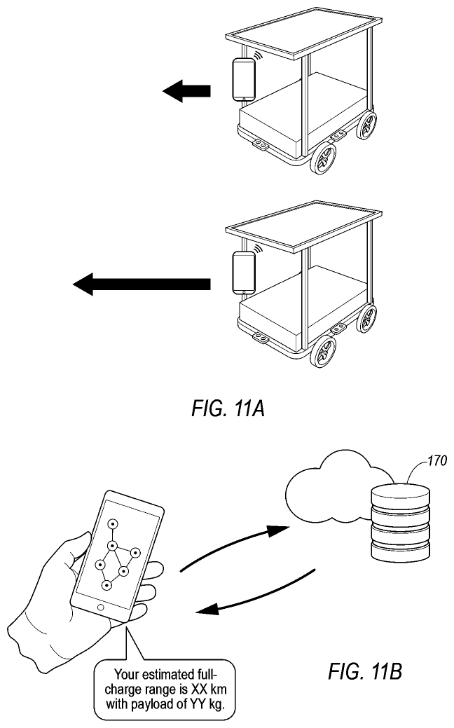

FIGS. 11A-11B are graphical representations of the performance estimation process. In FIG. 11A, the validation computer 145 may capture, via the camera 160, one or more videos of the vehicle moving in response to particular torque values commanded by the motor controller 125. Referring now to FIG. 11B, the validation computer 145 may send the videos, along with the graph generated at FIG. 10H, to the remote server 165. The remote server 165 may process the videos to determine the velocity and/or acceleration of the vehicle relative to the torque commanded by the motor controller 125. The remote server 165 may further consider the mass, friction, and other characteristics of the vehicle. The remote server 165 may transmit performance characteristics to the validation computer 145 based on the information received, and the validation computer 145 may display the performance characteristics on the display device 180. As discussed above, the performance characteristics may be further based on crowd-sourced information received from the validation computers 145 of other vehicles. That is, the remote server 165 may update its estimates of performance characteristics based on real-world performance of particular vehicles learned over time. In some instances, the validation computer 145 may be programmed to determine the performance characteristics locally (i.e., without having to transmit information to the remote server 165).

The validation computer 145 may be programmed to assist the manufacturer and/or operator of the vehicle in various ways. As discussed above, the validation computer 145 may help confirm that the kit 100 was assembled correctly, may provide a library menu of pictograms of viable reference designs/performance and instructions for integration, perform the various checks identified above in FIGS. 5-9, assess the performance rating (e.g., speed, range, payload), communicate information to the operator using the display device 180, provide an open source community with an expandable library of viable vehicle designs, and provide an authentication (PIN, facial recognition, voice recognition, fingerprint recognition, etc.) setup for the operator. Using machine learning and computer vision to assess characteristics of the vehicle such as weight and ground clearance from images uploaded by the manufacturer, the validation computer 145 may be programmed communicate the abuse threshold of the vehicle. The validation computer 145 may wirelessly communicate with the remote server 165 to implement one or more of these features.

The validation computer 145 may be powered by the generator 105 while the vehicle is in operation. The display device 180 may show information such as a map, speed, range remaining, battery state of charge, diagnostic warnings (such as battery overheating), and obstacle alerts. The information may be stored on the validation computer 145 or received from the remote server 165. Some of the information may be aggregated from other vehicles operating in a similar environment. The validation computer 145 may be programmed to receive and display notifications, including text messages. In addition to the notifications already discussed, the validation computer 145 may provide mid-route information, including a notification that a trip has been canceled. Text messages further allow for the user to call for help if needed.

As discussed above, the validation computer 145 may rely on location data, and possibly other information, to develop routes to a particular destination. The validation computer 145 may be programmed to calculate the lowest cost route after accounting for terrain, angle of inclines, weather changes relative to solar collection, likelihood of waterlogging based on weather conditions, etc. The validation computer 145 may be further programmed to calculate the most efficient solar panel 135 orientation for the duration of the trip along with instructions for manually adjusting the roof panel angle.

The camera 160 of the validation computer 145 can be used to estimate the terrain's rolling resistance. Machine learning software may take into consideration previous travel energy consumption to improve accuracy over time. Both can be used to increase range estimation. The camera 160 may be used to capture images of crops prior to transport in order to facilitate trade with more confidence.

The validation computer 145 may perform range estimation, based on state of charge, the range remaining in the vehicle, and the range left to travel. The validation computer 145 may advise the user on how to extend the range by, e.g., extending parking in sunlight at a mid-way arrival point, pedal more, reduce speed, remove some cargo, etc.

The validation computer 145 may include an accelerometer that can record potentially harmful forces (e.g., g-force above a certain magnitude) and the associated location where the force occurred in order to provide alerts to avoid that particular spot when making future trips. Microphone audio software may detect dangerous sounds and provide advisory alerts to the driver. Computer vision can also generate audible alerts for the driver if an obstacle (rock, puddle, animal, person, etc.) is detected ahead. Fusing these sensory inputs (camera 160, microphone, accelerometers) can allow for a more robust alert to be generated.

Security can be increased if the validation computer 145 requires authentication (e.g. password or fingerprint) prior to using the vehicle.

Wireless connectivity allows for diagnostics over, e.g., Bluetooth® on the vehicle, cellular connections, and loud data analytics/machine learning. Vehicle data can also be downloaded (from a USB stick) and provided to the validation computer 145 to analyze wear and tear and to diagnose failures before they occur and take preventive measures. It can also provide the operator with insight on how to operate the vehicle with more efficiency and less risk.

The validation computer 145 may include a data logger that tracks vehicle usage patterns and generates maps, which may be difficult to find in rural areas. The map data may be transmitted to the remote server 165 and provided to, e.g., governments and businesses.

A flashlight or camera light incorporated into the hardware of the validation computer 145 may provide some additional illumination at night. An Infrared camera may allow a longer recharging time during the day as it may make traveling at dusk a viable option.

The validation computer 145 may receive data from environmental sensors that may collect air samples to analyze pollution levels and transmit the data collected from the environmental sensors to the remote server 165. Other information captured and transmitted to the remote server 165 may include road quality, tree/forest coverage, etc.

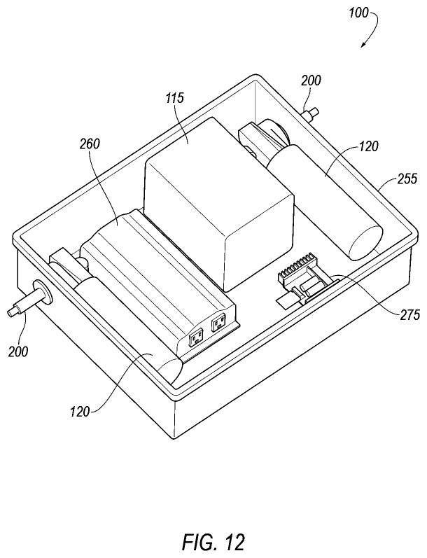

FIG. 12 is an example illustration of another example vehicle platform. The kit 100 shown in FIG. 12 includes a briefcase-style enclosure 255 that can house any of the components shown above, such as those shown in FIG. 1, 3, or 4. For purposes of simplicity, the enclosure 255 is shown housing the battery 115, electric motors 120, the motor controller 125, and inverters 260 to convert the direct current output by the battery 115 into alternating current to drive the electric motors 120. The electric motors 120 are each connected to a drive axle 200, and the drive axles 200 extend from either side of the enclosure 255.

The low profile of the kit 100 shown in FIG. 12 allows the kit 100 to be placed under objects that a user may wish to move. For instance, the kit 100 may be used in a hospital setting. In that implementation, the kit 100 may be placed under a hospital bed, wheelchair, or medical equipment that requires transportation. In other instances, the kit 100 may be placed under a cart, bicycle, or tricycle, to provide motor assist.

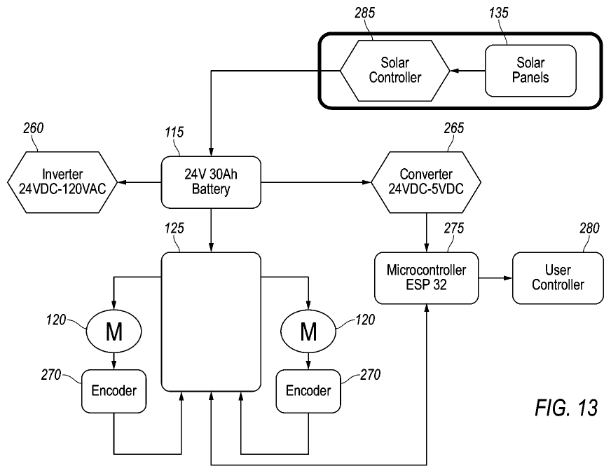

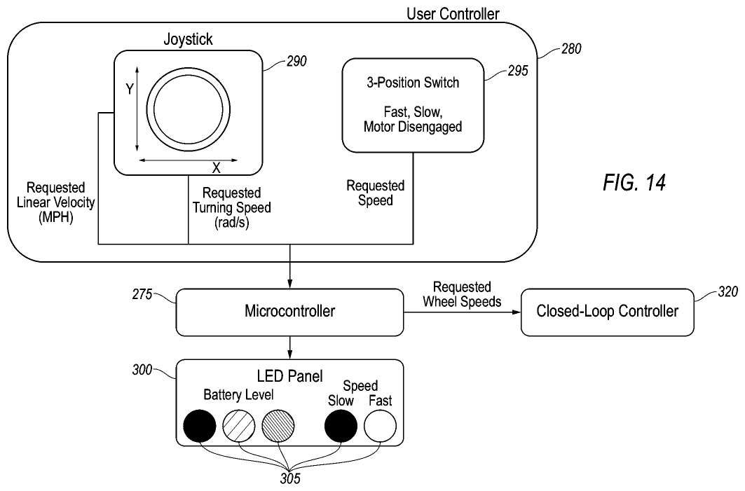

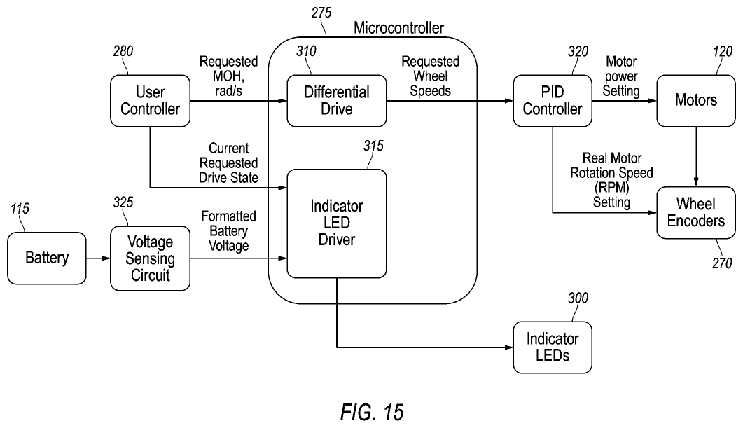

FIG. 13 is a block diagram showing example components of the kit 100 shown in FIG. 12. As illustrated in FIG. 13, the kit 100 includes the battery 115, inverters 260, a voltage converter 265, the motor controller 125, the electric motors 120, encoders 270, a microcontroller 275, and a user controller 280. The battery 115 may be charged via, e.g., solar panels 135 and a solar controller 285. The voltage converter 265 is an electrical circuit used to change the output voltage of the battery 115 to a voltage that is suitable for the microcontroller 275. For instance, the output voltage of the battery 115 may be 24 VDC, and the voltage converter 265 may output a voltage of 5 VDC to the microcontroller 275. The converter may include components such as resistors, capacitors, inductors, transistors, diodes, etc. The encoders 270 are electronic components that output a signal representing the rotation of the shafts of the electric motors 120. The output of the encoder 270 may be used, therefore, to detect whether the motor is rotating as commanded. The microcontroller 275 is implemented via circuits, chips, or other electronic components that can receive signals output by the user controller 280 and output commands to the motor controller 125 based on the signals output by the user controller 280. The user controller 280 is discussed in greater detail below with respect to FIG. 14 and the microcontroller 275 is discussed in greater detail below with respect to FIG. 15.

FIG. 14 is a block diagram showing example components of the user controller 280 used to control the kit 100 of FIG. 12. The user controller 280 includes a directional controller 290 and a speed switch 295. The directional controller 290 may include a joystick or directional pad that can receive a user input indicating a direction in which the kit 100 should travel. The directional controller 290 may output electronic signals representing the commanded direction. In some instances, the signals may represent a linear velocity, a turning speed, or both. The speed switch 295 may receive a user input indicating the speed at which the kit 100 should operate. Examples of speeds may include fast, slow, and off. The speed switch 295 may output a signal representing the user's desired speed for the kit 100.

In some possible approaches, the user controller 280 is implemented as a software application on a mobile device such as smartphone or tablet computer. In that implementation, the directional controller 290 and speed switch 295 may be presented virtually via a graphical user interface on, e.g., a touchscreen.

In another possible implementation, the user controller 280, particularly the directional controller 290 and/or speed switch 295, may include foot pedals. When implemented via foot pedals, the user may stand on the kit 100 and operate the kit 100 with his or her feet. For instance, manipulating one or more pedals may cause the kit 100 to accelerate or brake. Further, manipulating the pedals may allow the user to steer the kit 100.

Both the directional controller 290 and the speed switch 295 may output signals to the microcontroller 275. The microcontroller 275 may process the signals, as discussed in greater detail below, and output the signals to a closed-loop controller (see FIG. 15). Moreover, the microcontroller 275 may output the signals to a status panel 300 located on the kit 100 or on the user controller 280. The status panel 300 may include status identifiers 305 that show the amount of battery charge, the speed of the kit 100, or both. In one possible approach, the status identifiers 305 are light-emitting diodes. In another possible implementation, the status identifiers 305 are presented in a graphical user interface on a display device or touchscreen.

FIG. 15 is a block diagram illustrating an example controller for controlling the kit 100 of FIG. 12. As shown in FIG. 15, the microcontroller 275 includes a differential drive circuit 310 and a status panel driver 315.

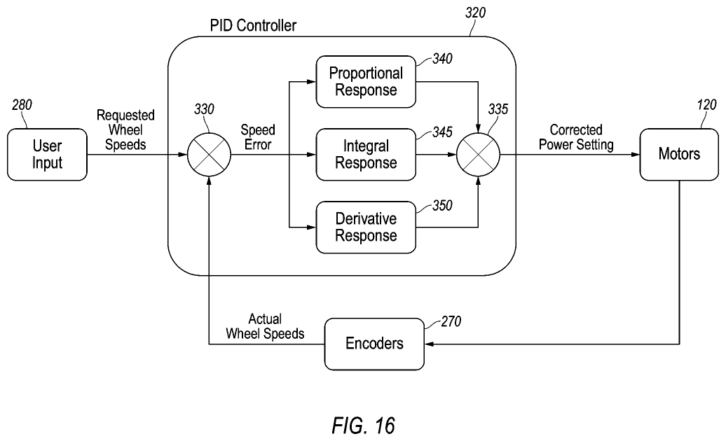

The differential drive circuit 310 is implemented via circuits, chips, or other electronic components that process signals output by the user controller 280, such as the commanded linear velocity, turning speed, and speed at which the kit 100 should operate. The differential drive circuit 310 processes those signals and outputs a wheel speed signal to a PID controller 320 (see FIG. 16). Although only one PID controller 320 is shown, the microcontroller 275 may output signals to multiple PID controllers 320, such as one PID controller 320 for each electric motor. The PID controller 320 may output a motor power setting signal that causes the electric motor to spin at a particular rotational speed. The PID controller 320 may further receive a signal from the encoder 270 representing the rotation of the motor, the wheel, or both. The PID controller 320 may use the signal from the encoder 270 to adjust the motor power setting signal.

The status panel driver 315 may receive signals from the user controller 280 and a voltage sensing circuit 325 of the battery 115. The voltage sensing circuit 325 may output a signal representing the battery state of charge. The status panel driver 315 may determine, from signals received from the user controller 280 and the voltage sensing circuit 325, the status of the kit 100 and output signals to the status panel 300 to illuminate the appropriate status identifiers 305, discussed above with respect to FIG. 14.

FIG. 16 is a block diagram of an example PID controller 320 (e.g., a closed-loop control system) shown in the block diagram of FIG. 15. The PID controller 320 includes a first summation block 330, a proportional response block 340, an integral response block 345, a derivative response block 350, and a second summation block 335.

The requested wheel speed is received at the first summation block 330, along with the actual wheel speed measured by the encoders 270. The first summation block 330 determines a wheel speed error by calculating the difference between the requested wheel speed and the actual wheel speed. The first summation block 330 outputs the error signal to the proportional response block 340, the integral response block 345, and the derivative response block 350.

The proportional response block 340 calculates and outputs a value proportional to the error signal output by the first summation block 330. For instance, the proportional response block 340 may multiply the value of the error determined by the first summation block 330 by a constant value. The result of the proportional response block 340 may be output to the second summation block 335.

The integral response block 345 calculates and outputs a value based on the integral of the error signal output by the first summation block 330. The integral response block 345 may calculate the integral over a set period of time and multiple the calculated integral by a constant value.

The derivative response block 350 calculates and outputs a value based on the derivative of the error signal to determine its rate of change. The derivative response block 350 may output the value to the second summation block 335.

The second summation block 335 may add the values of the proportional response block 340, the integral response block 345, and the derivative response block 350 to calculate a control variable that adjusts the power setting provided to the motor to reduce the error signal. The motors may control the wheel speed based on the control variable.

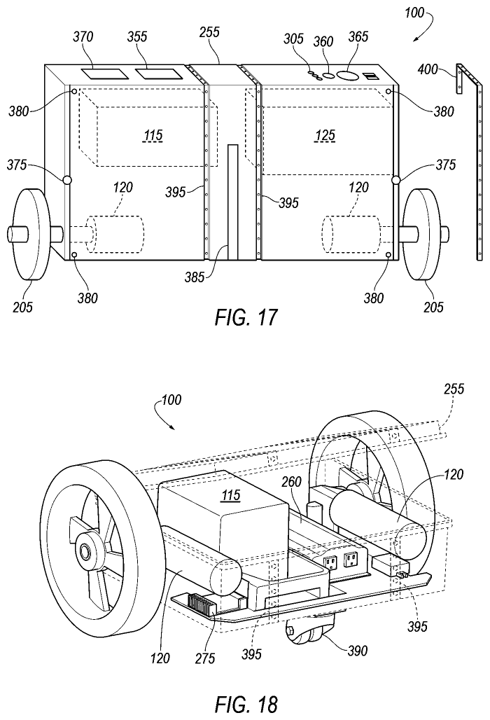

FIG. 17 is an illustration of another example vehicle platform having autonomous capabilities. In the example vehicle platform of FIG. 17, the kit 100 includes a telematics unit 335, a charging port 360, electrical outlets 365, an autonomous mode controller 370, sensors 375, the battery 115, and the solar panel connected to the motor controller 125. The telematics unit 335 is implemented via circuits, chips, or other electronic components that allow for wireless communication via a protocol such as Wi-Fi, 5G, LTE, or the like. In some instances, the telematics unit 335 facilitates wired or wireless communication with the user controller 280. The charging port 360 provides an electrical connection to a laptop computer, tablet computer, or other device such as a smartphone. The electrical outlets 365 provide an electrical connection such as electrical mains or ports such as universal serial bus (USB) ports.

The sensors 375 include cameras, lidar sensors, ultrasonic sensors, etc. that can detect the environment around the kit 100 and output signals to the autonomous mode controller 370 representing the environment around the kit 100. As shown, the sensors 375 are mounted near the edges of the enclosure 255. The edges may be beveled to give the sensors 375 a wider range of view.

The autonomous mode controller 370 is implemented via circuits, chips, or other electronic components that allow the kit 100 to operate autonomously. The autonomous mode controller 370 receives signals output by the sensors 375, generates control signals, and outputs the control signals to the motor controller 125. In doing so, the autonomous mode controller 370 may control the movement of the kit 100 based on the sensors 375 and without intervention from a user via, e.g., the user controller 280.

The platform further includes connection points 380 for attaching to an object to be moved. The connection points 380 may define holes for receiving a strap that wraps around part of the object to be moved. The strap may include a fastener such as a buckle or hook-and-loop fastener so the kit 100 can remain attached to the object during movement.

In another possible implementation, the connection points 380 may include magnets or electromagnets powered by the battery 115. The magnets or electromagnets may allow the kit 100 to connect to a corresponding magnetic plate located on the object to be moved. In the case of an electromagnet, the autonomous mode controller 370 may cause the battery 115 to electrically activate the electromagnet so it magnetically attaches to the magnetic plate located on the object to be moved. The magnets or electromagnets may maintain the magnetic connection to the magnetic plate while the kit 100 is moving the object.

Another option for the connection point may include a bracket. In some instances, the bracket may be height-adjustable, which may allow the kit 100 to be used with different objects. For instance, in a hospital setting, the same kit 100 can be used to transport a hospital bed, medical cart, and wheelchair.

Moreover, the kit 100 of FIG. 17 includes a slot 385 for attaching to other objects. For instance, the slot 385 may facilitate attaching the kit 100 to a part of an object such as a tire of a bicycle or tricycle to provide electric power assist. When used to transport medical equipment, the slot 385 may receive a part of the hospital bed or a medical cart.

In some possible implementations, the kit 100 may include a track 395 disposed about the periphery of the enclosure 255. Two tracks 395 are shown in the example of FIG. 17. A bracket 400 may fit inside the track 395, and the bracket may allow the kit 100 to attach to other objects and vehicles. The bracket 400 may be height-adjustable. That is, the bracket 400 may be positioned in the track 395 so the kit 100 may be attached to objects of varying heights. Holes in the bracket 400 and track 395 may receive a fastener, such as a screw or bolt, to hold the bracket 400 in place. In some possible approaches, the electromagnetic plate may be disposed on top of the bracket 400 rather than at the connection points 375 shown in FIG. 17. Further, although only one bracket 400 is shown, the kit 100 may come with additional brackets 400, such as a bracket 400 for each track 395. In addition or in the alternative, the kit 100 may come with brackets 400 of different configurations. For instance, the bracket 400 shown may be used when the kit 100 is used vertically (as shown) while a different bracket 400 may be used when the kit 100 is used horizontally (see FIG. 18). The bracket 400 may be metal or plastic.

FIG. 18 illustrates an example vehicle platform in a horizontal position as opposed to the vertical position shown in FIG. 17. When operating in the horizontal position, a caster wheel 390 may provide additional support and increase the stability of the kit 100. With the caster wheel 390, the kit 100 may be fully autonomous (e.g., operate at level 5 autonomy). That is, the kit 100 may be programmed to navigate to an object to be moved, connect to the object via the connection points 375 and/or bracket 400, and move the object to a desired or predetermined location without additional human interaction. In one use case, the kit 100 may autonomously navigate to a hospital bed, engage the electromagnetic plate to attach the kit 100 to the hospital bed, and autonomously move the hospital bed to a different room.

When the kit 100 includes a caster wheel 390, the slot 385 may be defined by a surface opposite the surface where the caster wheel 390 is located. Operating the kit 100 in the horizontal position may be desirable if the object to be moved has, e.g., a low ground clearance. For instance, the kit 100 may be used in a horizontal position so it may be placed under a hospital bed, medical cart, food cart, etc. Moreover, the kit 100 may be used in the horizontal position so the kit 100 may provide electric assist with a tire of a bicycle or tricycle inserted into the slot 385.

In general, the computing systems and/or devices described may employ any of a number of computer operating systems, including, but by no means limited to, versions and/or varieties of AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the OS X, macOS, and iOS operating systems distributed by Apple Inc. of Cupertino, Calif., the BlackBerry OS operating system distributed by Blackberry, Ltd. of Waterloo, Canada, and the Android operating system developed by Google, Inc. and the Open Handset Alliance. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A customizable power and propulsion kit comprising:
an enclosure;
an electric motor disposed in the enclosure;
a battery disposed in the enclosure and electrically connected to the electric motor; and
a connection point disposed on the enclosure, wherein the connection point facilitates connection of the kit to an object.

2. The customizable power and propulsion kit of claim 1, wherein the connection point includes an electromagnetic plate.

3. The customizable power and propulsion kit of claim 2, wherein the electromagnetic plate is electrically connected to the battery.

4. The customizable power and propulsion kit of claim 1, wherein the connection point defines a hole in the enclosure for receiving a strap.

5. The customizable power and propulsion kit of claim 1, wherein the connection point includes a track disposed about the periphery of the enclosure and a bracket.

6. The customizable power and propulsion kit of claim 1, further comprising a clutch mechanism operably connected to an output shaft of the electric motor and a gear system operably connected to the clutch mechanism.

7. The customizable power and propulsion kit of claim 6, further comprising a drive axle operably connected to the gear system.

8. The customizable power and propulsion kit of claim 1, further comprising a motor controller in signal communication with the battery.

9. The customizable power and propulsion kit of claim 1, further comprising a generator electrically connected to the battery.

10. The customizable power and propulsion kit of claim 1, further comprising at least one sensor and an autonomous mode controller programmed to autonomously control the kit based at least in part on an output of the sensor.

11. The customizable power and propulsion kit of claim 1, further comprising a validation computer having a memory and a processor programmed to execute instructions stored in the memory.

12. The customizable power and propulsion kit of claim 11, wherein the processor of the validation computer is programmed to perform at least one of:
an information connectivity check process,
an electrical connectivity check process,
a mechanical connectivity check process, and
a performance estimation process.

13. The customizable power and propulsion kit of claim 11, wherein the processor of the validation computer is programmed to receive an electronic image of vehicle component, digitally process the electronic image, and determine, from the digital processing, that the vehicle component was correctly assembled.

14. The customizable power and propulsion kit of claim 11, wherein the processor of the validation computer is programmed to receive location data, receive motion data, receive vehicle component data, and estimate vehicle performance based at least in part on the location data, the motion data, and the vehicle component data.

15. The customizable power and propulsion kit of claim 14, wherein the motion data includes at least one of a digital video and accelerometer data.

16. The customizable power and propulsion kit of claim 14, wherein the vehicle component data includes at least one of a voltage setting and a current setting associated with a vehicle component.

17. The customizable power and propulsion kit of claim 14, wherein the processor of the validation computer is programmed to receive performance data from a remote server and wherein estimating the vehicle performance further includes estimating the vehicle performance based at least in part on the performance data.

18. The customizable power and propulsion kit of claim 11, wherein the processor of the validation computer is programmed to receive environmental data, receive vehicle component data, and output, via a display device, a recommended configuration based at least in part on the environmental data and the vehicle component data.

19. The customizable power and propulsion kit of claim 18, wherein the recommended configuration includes an angle of a solar panel.

20. The customizable power and propulsion kit of claim 11, wherein the processor of the validation computer is programmed to receive environmental data, receive vehicle use data, and recommend a vehicle configuration based at least in part on the environmental data and the vehicle use data, wherein the vehicle configuration includes at least one of a battery size and an electric motor size.
